(19) United States
(12) Patent Application Publication
(10) Pub. No.: US 2017/0033952 A1
(43) Pub. Date: Feb. 2, 2017

(54) Systems and Methods for Back Channel Adaptation in a Serial Transfer

(71) Applicant: Avago Technologies General IP (Singapore) Pte. Ltd., SINGAPORE (SG)

(72) Inventors: Nayak Ratnakar Aravind, Allentown, PA (US); Mohammad Mobin, Orefield, PA (US)

(21) Appl. No.: 14/813,049

(22) Filed: Jul. 29, 2015

(51) Int. Cl. H04L 25/03; H04L 1/00; H04L 1/18; H04L 7/00

(52) U.S. Cl. CPC H04L 25/03057; H04L 7/0058; H04L 1/0042; H04L 1/0035; H04L 1/1867

(57) ABSTRACT

Embodiments are related to systems and methods for data processing, and more particularly to systems and methods for clock recovery in a data receiver.

### FIELD OF THE INVENTION

Embodiments are related to systems and methods for data processing, and more particularly to systems and methods for serial data transfer.

### BACKGROUND

A number of data transfer systems have been developed. Some transfer systems transfer clocked data without a clock. In such systems, the clock is recovered from the transferred data. In some cases, back channel signals are provided from a receiver to the transmitter to govern operation of circuitry in the transmitter. Such feedback signals may in some cases, however, actually degrade the operation of the data transfer system.

Hence, for at least the aforementioned reasons, there exists a need in the art for advanced systems and methods for enhancing sampling margins.

### BRIEF DESCRIPTION OF THE FIGURES

A further understanding of the various embodiments of the present invention may be realized by reference to the figures which are described in remaining portions of the specification. In the figures, like reference numerals are used throughout several figures to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1a shows a serial data transfer system including a serial data receiver having enhanced back channel adaptation circuitry in accordance with various embodiments of the present inventions;

FIG. 1b shows example operational plots representing functions of the serial data transfer system of FIG. 1a with the enhanced back channel adaptation circuitry disabled;

FIG. 1c shows example operational plots representing functions of the serial data transfer system of FIG. 1a with the enhanced back channel adaptation circuitry enabled;

FIG. 2 shows a serial data receiver including enhanced back channel adaptation circuitry in accordance with various embodiments of the present invention;

FIG. 3 is a flow diagram showing a method in accordance with some embodiments of the present invention for enhancing back channel feedback in accordance with some embodiments of the present invention;

FIG. 4 shows a serial data receiver including enhanced back channel adaptation circuitry in accordance with other embodiments of the present invention; and

FIG. 5 is a flow diagram showing a method in accordance with some embodiments of the present invention for enhancing back channel feedback in accordance with various embodiments of the present invention.

### DETAILED DESCRIPTION OF SOME EMBODIMENTS

Embodiments are related to systems and methods for data processing, and more particularly to systems and methods for serial data transfer.

Various embodiments of the present invention provide systems, methods and/or devices for back channel feedback in a data transmission system. Some embodiments of the present invention provide data transmission systems that include: a transmission circuit and a receiver circuit. The transmission circuit is operable to prepare a data input for transmission based at least in part on a back channel feedback data set to yield a data transfer set. The receiver circuit is operable to recover the data input from the data transfer set to yield a data output. The receiver circuit includes: a saturation detection circuit operable to identify a saturation condition; and a control feedback circuit operable to generate the back channel feedback data set based at least in part on the saturation condition. In some cases, the transmission circuit is a serial data transmission circuit and the receiver circuit is a serial data receiver circuit. In various cases, the transmission circuit includes a finite impulse response filter circuit, and the back channel feedback data set includes at least one coefficient governing operation of the finite impulse response filter circuit.

In one or more instances of the aforementioned embodiments, the receiver circuit includes: a variable gain amplifier circuit; and a data detector circuit. In some such instances, the data detector circuit is a decision feedback equalizer circuit. In various such instances, the saturation condition is identified when the variable gain amplifier circuit is operating at a range below a first threshold, and the data detector circuit is operating at a range above a second threshold. In some cases, both the first threshold and the second threshold are fixed. In other cases, the first threshold is fixed and the second threshold is user programmable. In further cases, the second threshold is fixed and the first threshold is user programmable. In yet other cases, both the first threshold and the second threshold are user programmable.

In some instances of the aforementioned embodiments, the receiver circuit further includes: a variable gain amplifier circuit, and a data detector circuit. In some such instances, the control feedback circuit is an adaptive control circuit operable to adaptively modify: a gain control output governing a level of the variable gain amplifier circuit; a data detector coefficient governing operation of the data detector circuit; and the back channel feedback data set where the adaptive control circuit is precluded from updating the back channel feedback data set when the saturation condition is identified.

In various instances of the aforementioned embodiments, the receiver circuit further includes: a variable gain amplifier circuit, and a data detector circuit. In some such instances, the control feedback circuit includes an adaptive control circuit and a back channel feedback modification circuit. The adaptive control circuit is operable to adaptively modify: a gain control output governing a level of the variable gain amplifier circuit; a data detector coefficient governing operation of the data detector circuit; and an interim feedback data set. The back channel feedback modification circuit is operable to provide the interim feedback data set is provided as the back channel feedback data set only when the saturation condition is not identified.

In some instances of the aforementioned embodiments, the back channel feedback data set is generated based upon a least mean squared error calculation. In one or more instances of the aforementioned embodiments, the system is implemented as part of a storage device. In particular instances of the aforementioned embodiments, the system is implemented as part of an integrated circuit.

Other embodiments of the present invention provide methods for serial data transfer that include: receiving an input data set by a receiver circuit, wherein the input data set is derived from a transmission circuit where operation of the transmission circuit is at least in part governed by a back channel feedback data set; applying a variable gain amplification of an analog signal corresponding to the input data set to yield an amplified signal where a gain of the variable gain amplification is controlled at least in part by a gain control output; applying a data detection algorithm to a detector input derived from the amplified signal to yield a detected output where a data detector coefficient at least in part controls application of the data detection algorithm; determining a saturation condition based at least in part on a combination of the data detector coefficient and the gain control output; and when the saturation condition is identified, precluding an update of the back channel feedback data set.

In some instances of the aforementioned embodiments, the methods further include: receiving a user data set; and using the transmission circuit to generate the input data based on the back channel feedback data set. In such instances, the transmission circuit includes a finite impulse response filter and the back channel feedback data set includes at least one coefficient governing operation of the finite impulse response filter. In one or more instances of the aforementioned embodiments, the data detection algorithm is a decision feedback equalizer algorithm applied by a decision feedback equalizer circuit, and the variable gain amplification is applied by a variable gain amplifier circuit. In some such instances, the saturation condition is identified when the variable gain amplifier circuit is operating at a range below a first threshold, and the data detector circuit is operating at a range above a second threshold. In one or more instances of the aforementioned embodiments, precluding an update of the back channel feedback data set includes disabling a calculation of the back channel feedback data set such that a previous instance of the back channel feedback data set remains valid. In other instances of the aforementioned embodiments, precluding an update of the back channel feedback data set includes providing a prior instance of the back channel feedback data set when the saturation condition is identified.

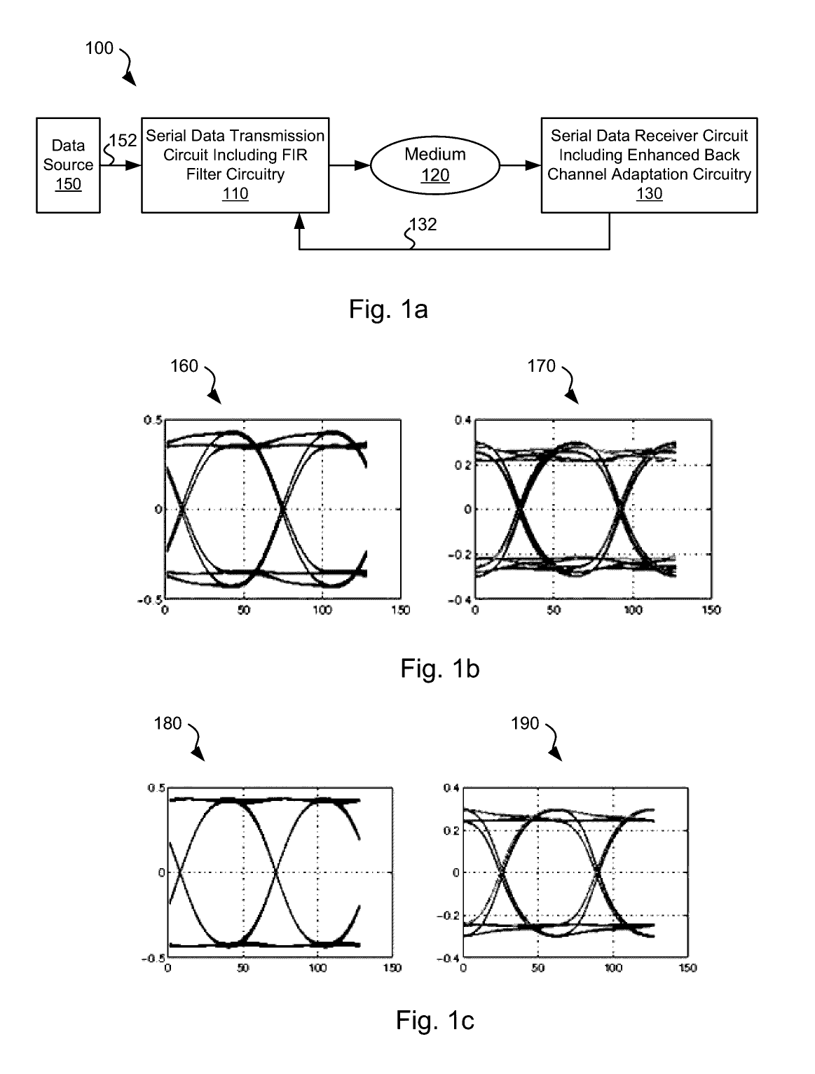

Turning to FIG. 1, a serial data transfer system 100 is shown that includes a serial data transmission circuit 110 and a serial data receiver circuit 130. Serial data transmission circuit 110 may be any circuit known in the art for generating a stream a serial data to be transferred to serial data receiver circuit 130 via a medium 120. Based upon the disclosure provided herein, one of ordinary skill in the art will recognize a variety of data transmission circuitry that may be used in relation to different embodiments of the present invention. Operation of the aforementioned data transmission circuitry is governed at least in part based upon a back channel feedback data set 132 generated by serial data receiver circuit 130. Based upon the disclosure provided herein, one of ordinary skill in the art will recognize one or more signals including, but not limited to, filter coefficients for an finite impulse response filter that may be included in back channel feedback data set 132. Further, based upon the disclosure provided herein, one of ordinary skill in the art will recognize one or more circuits within serial data transmission circuit 110 that may be governed based at least in part on back channel feedback data set 132.

Medium 120 may be, but is not limited to, a wired or wireless transfer medium. Such wired transfer mediums may be a metal wire transfer medium capable of transmitting electrical signal, or may be an optical transfer medium capable of transferring light. Based upon the disclosure provided herein, one of ordinary skill in the art will recognize a variety of wired transfer media that may be used in relation to different embodiments of the present invention. The aforementioned wireless transfer mediums may be an atmosphere capable of transmitting, for example, radio frequency signals. Based upon the disclosure provided herein, one of ordinary skill in the art will recognize a variety of wireless transfer media that may be used in relation to different embodiments of the present invention.

Serial data receiver circuit 130 receives the serial data via medium 120. The received serial data is sampled and the sampled data is provided to one or more circuits (not shown) for processing. As part of receiving the serial data, a clock is recovered from the received serial data and used to process the incoming serial data. Serial data receiver circuit 130 includes an adaptive control feedback that generates interim elements corresponding to channel feedback data set 132. Such interim elements corresponding to back channel feedback data set 132 may be any elements currently used as part of feedback control in existing systems.

In addition, serial data receiver circuit 130 includes enhanced back channel adaptation circuitry able to selectively modify the interim elements corresponding to back channel feedback data set 132 to yield the actual back channel feedback data set 132 provided to serial data transmission circuit 110. In one particular embodiment, serial data receiver circuit 130 includes a saturation detection circuit that determines whether a saturation condition exists. In one case, a saturation condition is determined to exist when both an gain control output is set such that a variable gain amplifier of the serial data receiver circuit is adapting at a very low gain and a data detector coefficient is set such that a data slicer circuit (e.g., a decision feedback equalizer circuit (DFE)) is adapting at the high end of its allowed range. When the saturation condition is not detected, the interim elements corresponding to back channel feedback data set 132 are provided directly as back channel feedback data set 132. Otherwise, when the saturation condition is detected, the interim elements corresponding to back channel feedback data set 132 are not provided directly as back channel feedback data set 132. Rather, the prior instance of the interim elements are provided again as back channel feedback data set 132.

In some cases, serial data transfer system 100 is implemented as part of a storage device including a storage medium and a read/write head assembly disposed in relation to the storage medium. In such cases, data transferred to/from the storage medium is transferred as a serial data stream generated by serial data transfer system 100. Based upon the disclosure provided herein, one of ordinary skill in the art will recognize a variety of devices in which serial data transfer system 100 may be implemented or deployed.

Turning to FIG. 1b, a channel output plot 160 shows an example of the input to serial data receiver 130 from medium 120 where the enhanced back channel adaptation circuitry is disabled. In addition, a processed analog output plot 170 shows an example of an output of an analog front end circuit (not shown) included in serial data receiver 130 where the enhanced back channel adaptation circuitry is disabled.

Turning to FIG. 1c, a channel output plot 180 shows an example of the input to serial data receiver 130 from medium 120 where the enhanced back channel adaptation circuitry is enabled. In addition, a processed analog output plot 190 shows an example of an output of an analog front end circuit (not shown) included in serial data receiver 130 where the enhanced back channel adaptation circuitry is enabled. Notably the signals resulting from the use of the enhanced back channel adaptation circuitry that does not update back channel feedback data set 132 when the previously described saturation condition is identified (i.e., the signals shown in FIG. 1c) exhibit less noise when compared with the corresponding signals generated when the enhanced back channel adaptation circuitry is disabled (i.e., the signals shown in FIG. 1b).

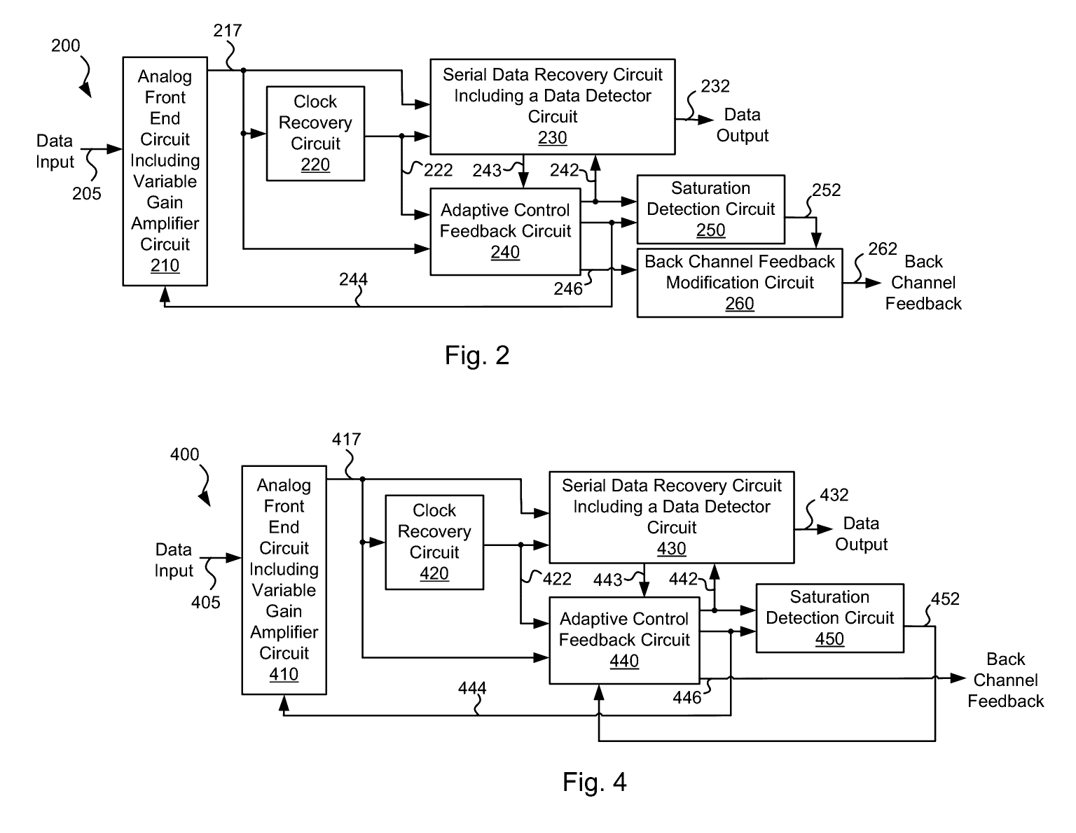

Turning to FIG. 2, a serial data receiver 200 including enhanced back channel adaptation circuitry is shown in accordance with various embodiments of the present invention. Serial data receiver 200 includes an analog front end circuit 210 that applies analog processing to a data input 205 to yield a processed analog input 217. Analog front end circuit 210 may include, but is not limited to, an analog filter circuit and a variable gain amplifier circuit. Based upon the disclosure provided herein, one of ordinary skill in the art will recognize a variety of circuitry that may be included as part of analog front end circuit 210. The gain applied by the aforementioned variable gain amplifier circuit is governed by a gain control output 244.

Processed analog input 217 is provided to a clock recovery circuit 220 that is capable of generating a data clock 222 based upon the received input. Clock recovery circuit 220 may be any circuit known in the art that is capable of recovering or generating a clock signal synchronous to a serial data stream. Based upon the disclosure provided herein, one of ordinary skill in the art will recognize a variety of clock recovery circuits that may be used in relation to different embodiments of the present invention.

Processed analog input 217 is also provided to a serial data recovery circuit 230 that is capable of recovering a data output 232 from the received input. Serial data recovery circuit 230 processes data synchronous to data clock 222. Serial data recovery circuit 230 includes a decision feedback equalizer circuit that operates as a data detector identifying individual data elements in processed analog input 217. Based upon the disclosure provided herein, one of ordinary skill in the art will recognize a variety of circuitry that may be included as part of serial data recovery circuit 230. The threshold applied by the aforementioned decision feedback equalizer circuit is governed at least in part based upon a data detector coefficient 242.

An adaptive control feedback circuit 240 adaptively modifies data detector coefficient 242, gain control output 244 and an interim feedback data set 246. Interim feedback data set 246 is the basis for back channel control and as such is generated to control one or more circuits included in an upstream data transmission circuit (not shown). Adaptation of interim feedback data set 246 is used to adjust equalization coefficients of an upstream serial data transmitter (not shown) based on some parameters that are measured or sensed in serial data receiver 200. For example, where it is determined that the range of the equalization capability in serial data receiver 200 is insufficient, interim feedback data set 246 is modified to increase the amount of equalization applied by the upstream serial data transmitter. As another example, when the channel between the serial data transmitter and serial data receiver 200 adds noise along with inter-symbol interference (ISI), interim feedback data set 246 may provide control to the serial data transmitter to boost the signal prior to transmission via the channel. Such an approach avoids boosting both signal and noise where the boost is applied in serial data receiver 200 instead of the upstream serial data transmitter. Such an approach may lead to an increase in signal to noise ratio of signals processed by serial data receiver 200. In some embodiments, adaptation of data detector coefficient 242, gain control output 244 and interim feedback data set 246 may be done using any adaptation approach known in the art for adapting the aforementioned feedback data. In one particular case, the aforementioned adaptation is done using a least mean squared adaptation algorithm using an error value 243 generated based upon the output of the decision feedback equalizer circuit included in serial data recovery circuit 230 as is known in the art.

Data detector coefficient 242 and gain control output 244 are provided to a saturation detection circuit 250 that uses the received inputs to identify a saturation condition. In some embodiments, the saturation condition is defined as a combination of the variable gain amplifier circuit operating at a range below a first threshold and the DFE circuit operating at a range above a second threshold. Such may be determined by comparing gain control output 244 with the first threshold and comparing data detector coefficient 242 with the second threshold. In some cases, both the first threshold and the second threshold are fixed. In other cases, the first threshold is fixed and the second threshold is user programmable. In further cases, the second threshold is fixed and the first threshold is user programmable. In yet other cases, both the first threshold and the second threshold are user programmable. Where the conditions of the saturation condition are met, saturation detection circuit 250 asserts a saturation output 252 indicating identification of the saturation condition.

Where the saturation condition is identified as indicated by saturation output 252, a back channel feedback modification circuit 260 provides a prior instance of interim feedback data set 246 as a back channel feedback data set 262. Alternatively, where the saturation condition is not identified as indicated by saturation output 252, a back channel feedback modification circuit 260 provides interim feedback data set 246 as back channel feedback data set 262. Back channel feedback data set 262 is provided to the upstream data transmitter similar to that discussed above in relation to FIG. 1a. To facilitate the proper updating of back channel feedback data set 262, back channel feedback modification circuit 260 includes a buffer (not shown) for storing the prior instance of back channel feedback data set 262 and a selector circuit (not shown) for selecting between the prior instance of back channel feedback data set 262 and the current instance of interim feedback data set 246 to be provided as the current instance of back channel feedback data set 262.

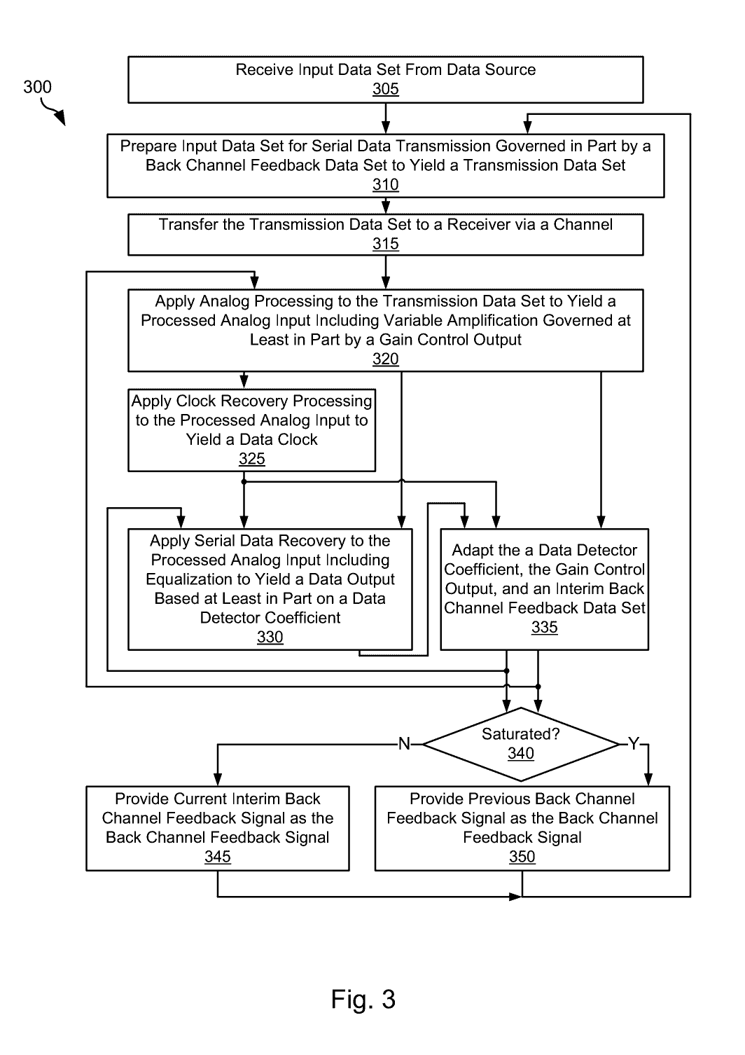

Turning to FIG. 3, a flow diagram 300 shows a method in accordance with some embodiments of the present invention for enhancing back channel feedback in accordance with some embodiments of the present invention. Following flow diagram 300, an input data set is received from a data source (bock 305). The data source may be any source of data known in the art. In one particular embodiment, the data source is a read channel of a hard disk drive system. Based upon the disclosure provided herein, one of ordinary skill in the art will recognize a variety of data sources from which data may be received in accordance with different embodiments of the present invention.

The received input data set is prepared for serial data transmission to yield a transmission data set (block 310). Preparing the input data set for transmission may include any processes known in the art for preparing a data set for serial data transmission. Such processes may include, but are not limited to, variable gain amplification and/or equalization. Either or both of the aforementioned variable gain amplification and equalization may be governed at least in part by a back channel feedback data set generated by a downstream circuit receiving and processing the transmission data set. The transmission data set is then transferred to a receiver (i.e., the downstream circuit receiving and processing the transmission data set) via a channel (block 315). Any process known in the art for transferring serial data from a transmission circuit to a receiver circuit via a channel may be used to effectuate the transfer.

At the receiver, analog processing is applied to the transmission data set to yield a processed analog input (block 320). The analog processing may include, but is not limited to, analog filtering and/or variable gain amplification. Based upon the disclosure provided herein, one of ordinary skill in the art will recognize a variety of analog processing that may be included as part of the aforementioned analog processing. The gain applied by the aforementioned variable gain amplification is governed by a gain control output.

Clock recovery processing is applied to the processed analog input to yield a data clock (block 325). The clock recovery processing may be done using any clock recovery circuit known in the art that is capable of recovering or generating a clock signal synchronous to a serial data stream. Based upon the disclosure provided herein, one of ordinary skill in the art will recognize a variety of clock recovery circuits that may be used in relation to different embodiments of the present invention.

A serial data recovery process is applied to the processed analog input synchronous to the data clock to yield a data output (block 330). The serial data recovery process may be done by a serial data recovery circuit that includes a decision feedback equalizer circuit that operates as a data detector identifying individual data elements in the processed analog input. Based upon the disclosure provided herein, one of ordinary skill in the art will recognize a variety of circuitry that may be included as part of the serial data recovery circuit. The threshold applied by the aforementioned decision feedback equalizer circuit is governed at least in part based upon the data detector coefficient.

The data detector coefficient, the gain control output, and an interim back channel feedback data set are adapted (block 335). In some cases, the adaptation is done using a least mean squared adaptation algorithm using an error value resulting from the serial data recovery process as is known in the art. The interim back channel feedback data set is the basis for back channel control and as such is generated to control one or more circuits included in an upstream data transmission circuit. Adaptation of the interim feedback data set is used to adjust equalization coefficients of an upstream serial data transmitter based on some parameters that are measured or sensed in a downstream data receiver. For example, where it is determined that the range of the equalization capability in the data receiver is insufficient, the interim feedback data set is modified to increase the amount of equalization applied by the upstream serial data transmitter. As another example, when the channel between the serial data transmitter and the serial data receiver adds noise along with inter-symbol interference (ISI), the interim feedback data set may provide control to the serial data transmitter to boost the signal prior to transmission via the channel. Such an approach avoids boosting both signal and noise where the boost is applied in the serial data receiver instead of the upstream serial data transmitter. Such an approach may lead to an increase in signal to noise ratio of signals processed by the serial data receiver.

It is determined whether a saturation condition exists (block 340). In one case, a saturation condition is determined to exist when both a gain control output is set such that a variable gain amplifier of a serial data receiver circuit is adapting at a very low gain and a data detector coefficient is set such that a data slicer circuit (e.g., a decision feedback equalizer circuit (DFE)) is adapting at the high end of its allowed range. When the saturation condition is not detected (block 340), the current interim back channel feedback data set is provided as the back channel feedback data set (block 345). Alternatively, when the saturation condition is detected (block 340), the previous back channel feedback data set is provided as the current back channel feedback data set (block 350).

Turning to FIG. 4, a serial data receiver 400 including enhanced back channel adaptation circuitry is shown in accordance with other embodiments of the present invention. Serial data receiver 400 includes an analog front end circuit 410 that applies analog processing to a data input 405 to yield a processed analog input 417. Analog front end circuit 410 may include, but is not limited to, an analog filter circuit and a variable gain amplifier circuit. Based upon the disclosure provided herein, one of ordinary skill in the art will recognize a variety of circuitry that may be included as part of analog front end circuit 410. The gain applied by the aforementioned variable gain amplifier circuit is governed by a gain control output 444.

Processed analog input 417 is provided to a clock recovery circuit 420 that is capable of generating a data clock 422 based upon the received input. Clock recovery circuit 420 may be any circuit known in the art that is capable of recovering or generating a clock signal synchronous to a serial data stream. Based upon the disclosure provided herein, one of ordinary skill in the art will recognize a variety of clock recovery circuits that may be used in relation to different embodiments of the present invention.

Processed analog input 417 is also provided to a serial data recovery circuit 430 that is capable of recovering a data output 432 from the received input. Serial data recovery circuit 430 processes data synchronous to data clock 422. Serial data recovery circuit 430 includes a decision feedback equalizer circuit that operates as a data detector identifying individual data elements in processed analog input 417. Based upon the disclosure provided herein, one of ordinary skill in the art will recognize a variety of circuitry that may be included as part of serial data recovery circuit 430. The threshold applied by the aforementioned decision feedback equalizer circuit is governed at least in part based upon a data detector coefficient 442.

An adaptive control feedback circuit 440 adaptively modifies data detector coefficient 442, gain control output 444 and a back channel feedback data set 446. Back channel feedback data set 446 is the basis for back channel control and as such is generated to control one or more circuits included in an upstream data transmission circuit (not shown). Adaptation of back channel feedback data set 446 is used to adjust equalization coefficients of an upstream serial data transmitter (not shown) based on some parameters that are measured or sensed in serial data receiver 400. For example, where it is determined that the range of the equalization capability in serial data receiver 400 is insufficient, back channel feedback data set 446 is modified to increase the amount of equalization applied by the upstream serial data transmitter. As another example, when the channel between the serial data transmitter and serial data receiver 400 adds noise along with inter-symbol interference (ISI), back channel feedback data set 446 may provide control to the serial data transmitter to boost the signal prior to transmission via the channel. Such an approach avoids boosting both signal and noise where the boost is applied in serial data receiver 400 instead of the upstream serial data transmitter. Such an approach may lead to an increase in signal to noise ratio of signals processed by serial data receiver 400. In some embodiments, adaptation of data detector coefficient 442, gain control output 444 and back channel feedback data set 446 may be done using any adaptation approach known in the art for adapting the aforementioned feedback data. In one particular case, the aforementioned adaptation is done using a least mean squared adaptation algorithm using an error value 443 generated based upon the output of the decision feedback equalizer circuit included in serial data recovery circuit 430 as is known in the art.

Data detector coefficient 442 and gain control output 444 are provided to a saturation detection circuit 450 that uses the received inputs to identify a saturation condition. In some embodiments, the saturation condition is defined as a combination of the variable gain amplifier circuit operating at a range below a first threshold and the DFE circuit operating at a range above a second threshold. Such may be determined by comparing gain control output 444 with the first threshold and comparing data detector coefficient 442 with the second threshold. In some cases, both the first threshold and the second threshold are fixed. In other cases, the first threshold is fixed and the second threshold is user programmable. In further cases, the second threshold is fixed and the first threshold is user programmable. In yet other cases, both the first threshold and the second threshold are user programmable. Where the conditions of the saturation condition are met, saturation detection circuit 450 asserts an adaptation enable signal 452 indicating identification of the saturation condition.

Where the saturation condition is identified as indicated by adaptation enable signal 452, updating back channel feedback data set 446 by adaptive control feedback circuit 440 is disabled. Alternatively, where the saturation condition is not identified as indicated by adaptation enable signal 452, updating back channel feedback data set 446 by adaptive control feedback circuit 440 is enabled.

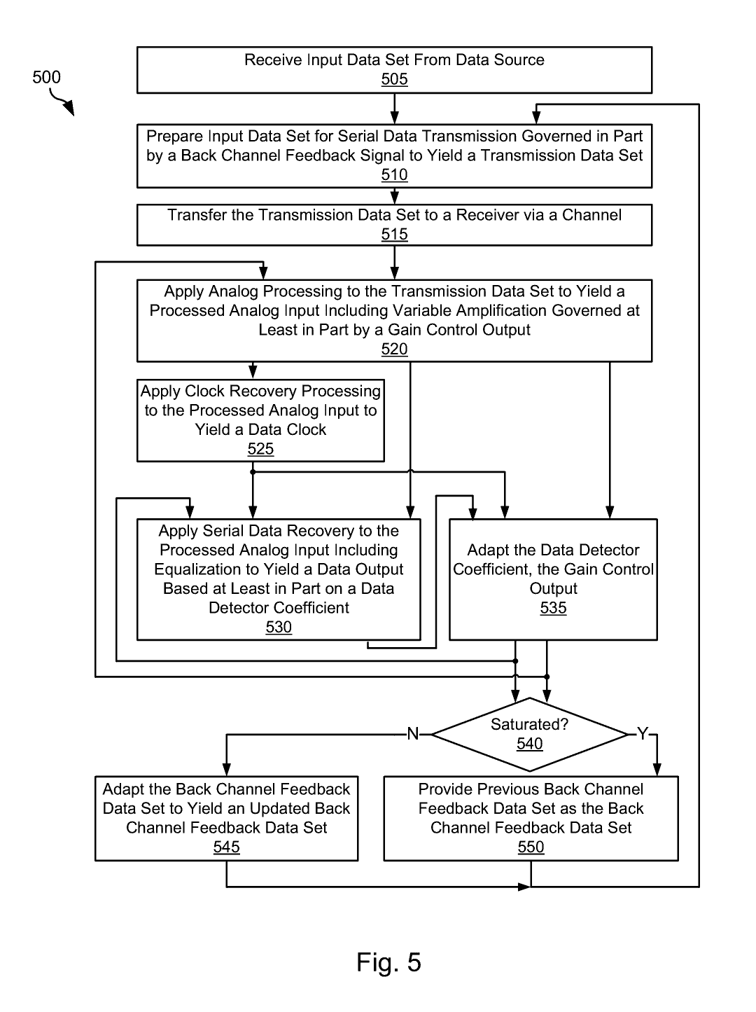

Turning to FIG. 5, a flow diagram 500 shows a method in accordance with some embodiments of the present invention for enhancing back channel feedback in accordance with various embodiments of the present invention. Following flow diagram 500, an input data set is received from a data source (bock 505). The data source may be any source of data known in the art. In one particular embodiment, the data source is a read channel of a hard disk drive system. Based upon the disclosure provided herein, one of ordinary skill in the art will recognize a variety of data sources from which data may be received in accordance with different embodiments of the present invention.

The received input data set is prepared for serial data transmission to yield a transmission data set (block 510). Preparing the input data set for transmission may include any processes known in the art for preparing a data set for serial data transmission. Such processes may include, but are not limited to, variable gain amplification and/or equalization. Either or both of the aforementioned variable gain amplification and equalization may be governed at least in part by a back channel feedback data set generated by a downstream circuit receiving and processing the transmission data set. The transmission data set is then transferred to a receiver (i.e., the downstream circuit receiving and processing the transmission data set) via a channel (block 515). Any process known in the art for transferring serial data from a transmission circuit to a receiver circuit via a channel may be used to effectuate the transfer.

At the receiver, analog processing is applied to the transmission data set to yield a processed analog input (block 520). The analog processing may include, but is not limited to, analog filtering and/or variable gain amplification. Based upon the disclosure provided herein, one of ordinary skill in the art will recognize a variety of analog processing that may be included as part of the aforementioned analog processing. The gain applied by the aforementioned variable gain amplification is governed by a gain control output.

Clock recovery processing is applied to the processed analog input to yield a data clock (block 525). The clock recovery processing may be done using any clock recovery circuit known in the art that is capable of recovering or generating a clock signal synchronous to a serial data stream. Based upon the disclosure provided herein, one of ordinary skill in the art will recognize a variety of clock recovery circuits that may be used in relation to different embodiments of the present invention.

A serial data recovery process is applied to the processed analog input synchronous to the data clock to yield a data output (block 530). The serial data recovery process may be done by a serial data recovery circuit that includes a decision feedback equalizer circuit that operates as a data detector identifying individual data elements in the processed analog input. Based upon the disclosure provided herein, one of ordinary skill in the art will recognize a variety of circuitry that may be included as part of the serial data recovery circuit. The threshold applied by the aforementioned decision feedback equalizer circuit is governed at least in part based upon the data detector coefficient.

The data detector coefficient and the gain control output are adapted (block 535). In some cases, the adaptation is done using a least mean squared adaptation algorithm using an error value resulting from the serial data recovery process as is known in the art. Based upon the disclosure provided herein, one of ordinary skill in the art will recognize a variety of adaptation processes that may be used in relation to different embodiments of the present invention.

It is determined whether a saturation condition exists (block 540). In one case, a saturation condition is determined to exist when both a gain control output is set such that a variable gain amplifier of a serial data receiver circuit is adapting at a very low gain and a data detector coefficient is set such that a data slicer circuit (e.g., a decision feedback equalizer circuit (DFE)) is adapting at the high end of its allowed range.

When the saturation condition is not detected (block 540), the back channel feedback data set is adapted to yield an updated back channel feedback data set (block 545). The back channel feedback data set is the basis for back channel control and as such is generated to control one or more circuits included in an upstream data transmission circuit. Adaptation of the back channel feedback data set is used to adjust equalization coefficients of an upstream serial data transmitter based on some parameters that are measured or sensed in a downstream data receiver. For example, where it is determined that the range of the equalization capability in the data receiver is insufficient, the back channel feedback data set is modified to increase the amount of equalization applied by the upstream serial data transmitter. As another example, when the channel between the serial data transmitter and the serial data receiver adds noise along with inter-symbol interference (ISI), the back channel feedback data set may provide control to the serial data transmitter to boost the signal prior to transmission via the channel. Such an approach avoids boosting both signal and noise where the boost is applied in the serial data receiver instead of the upstream serial data transmitter. Such an approach may lead to an increase in signal to noise ratio of signals processed by the serial data receiver. Alternatively, when the saturation condition is detected (block 540), the previous back channel feedback data set is provided as the current back channel feedback data set (block 550).

It should be noted that the various blocks discussed in the above application may be implemented in integrated circuits along with other functionality. Such integrated circuits may include all of the functions of a given block, system or circuit, or a subset of the block, system or circuit. Further, elements of the blocks, systems or circuits may be implemented across multiple integrated circuits. Such integrated circuits may be any type of integrated circuit known in the art including, but are not limited to, a monolithic integrated circuit, a flip chip integrated circuit, a multichip module integrated circuit, and/or a mixed signal integrated circuit. It should also be noted that various functions of the blocks, systems or circuits discussed herein may be implemented in either software or firmware. In some such cases, the entire system, block or circuit may be implemented using its software or firmware equivalent, albeit such a system would not be a circuit. In other cases, the one part of a given system, block or circuit may be implemented in software or firmware, while other parts are implemented in hardware.

In conclusion, the invention provides novel systems, devices, methods and arrangements for data processing. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A data transfer system, the system comprising:
a transmission circuit operable to prepare a data input for transmission based at least in part on a back channel feedback data set to yield a data transfer set;
a receiver circuit operable to recover the data input from the data transfer set to yield a data output, wherein the receiver circuit includes:
a saturation detection circuit operable to identify a saturation condition; and
a control feedback circuit operable to generate the back channel feedback data set based at least in part on the saturation condition.

2. The data transfer system of claim 1, wherein the transmission circuit is a serial data transmission circuit and the receiver circuit is a serial data receiver circuit.

3. The data transfer system of claim 1, wherein the transmission circuit includes a finite impulse response filter circuit, and wherein the back channel feedback data set includes at least one coefficient governing operation of the finite impulse response filter circuit.

4. The data transfer system of claim 1, wherein the receiver circuit includes:
a variable gain amplifier circuit; and
a data detector circuit.

5. The data transfer system of claim 4, wherein the data detector circuit is a decision feedback equalizer circuit.

6. The data transfer system of claim 4, wherein the saturation condition is identified when the variable gain amplifier circuit is operating at a range below a first threshold, and the data detector circuit is operating at a range above a second threshold.

7. The data transfer system of claim 6, wherein at least one of the first threshold and the second threshold is user programmable.

8. The data transfer system of claim 1, wherein the receiver circuit further includes:
a variable gain amplifier circuit;
a data detector circuit; and
wherein the control feedback circuit is an adaptive control circuit operable to adaptively modify:
a gain control output governing a level of the variable gain amplifier circuit;
a data detector coefficient governing operation of the data detector circuit; and
the back channel feedback data set, wherein the adaptive control circuit is precluded from updating the back channel feedback data set when the saturation condition is identified.

9. The data transfer system of claim 1, wherein the receiver circuit further includes:
a variable gain amplifier circuit;
a data detector circuit;
wherein the control feedback circuit includes an adaptive control circuit and a back channel feedback modification circuit;
wherein the adaptive control circuit is operable to adaptively modify:
a gain control output governing a level of the variable gain amplifier circuit;
a data detector coefficient governing operation of the data detector circuit; and
an interim feedback data set; and
wherein the back channel feedback modification circuit is operable to provide the interim feedback data set is provided as the back channel feedback data set only when the saturation condition is not identified.

10. The data transfer system of claim 1, wherein the back channel feedback data set is generated based upon a least mean squared error calculation.

11. The data transfer system of claim 1, wherein the system is implemented as part of a storage device.

12. The data transfer system of claim 1, wherein the system is implemented as part of an integrated circuit.

13. A method for serial data transfer, the method comprising:
receiving an input data set by a receiver circuit, wherein the input data set is derived from a transmission circuit, wherein operation of the transmission circuit is at least in part governed by a back channel feedback data set;
applying a variable gain amplification of an analog signal corresponding to the input data set to yield an amplified signal, wherein a gain of the variable gain amplification is controlled at least in part by a gain control output;
applying a data detection algorithm to a detector input derived from the amplified signal to yield a detected output, wherein a data detector coefficient at least in part controls application of the data detection algorithm;
determining a saturation condition based at least in part on a combination of the data detector coefficient and the gain control output; and
when the saturation condition is identified, precluding an update of the back channel feedback data set.

14. The method of claim 13, wherein the method further comprises:
receiving a user data set; and
using the transmission circuit to generate the input data based on the back channel feedback data set, wherein the transmission circuit includes a finite impulse response filter and the back channel feedback data set includes at least one coefficient governing operation of the finite impulse response filter.

15. The method of claim 13, wherein the data detection algorithm is a decision feedback equalizer algorithm applied by a decision feedback equalizer circuit, and wherein the variable gain amplification is applied by a variable gain amplifier circuit.

16. The method of claim 15, wherein the saturation condition is identified when the variable gain amplifier circuit is operating at a range below a first threshold, and the data detector circuit is operating at a range above a second threshold.

17. The method of claim 13, wherein precluding an update of the back channel feedback data set includes disabling a calculation of the back channel feedback data set such that a previous instance of the back channel feedback data set remains valid.

18. The method of claim 13, wherein precluding an update of the back channel feedback data set includes providing a prior instance of the back channel feedback data set when the saturation condition is identified.

19. A data transfer system, the system comprising:
a receiver circuit operable to recover a data input from a transfer data set received via a channel, wherein the data input is generated at least in part based upon back channel feedback data set, and wherein the receiver circuit includes:
a data detector circuit;
a variable gain amplifier circuit;
a saturation detection circuit operable to identify a saturation condition, wherein the saturation condition is identified when the variable gain amplifier circuit is operating at a range below a first threshold, and the data detector circuit is operating at a range above a second threshold; and
a control feedback circuit operable to generate the back channel feedback data set based at least in part on the saturation condition.

20. The data transfer system of claim 19, the system further comprising:
a transmission circuit operable to generate the data input, wherein the transmission circuit includes a finite impulse response filter circuit, and wherein the back channel feedback data set includes at least one coefficient governing operation of the finite impulse response filter circuit.
